(19) United States
(12) Patent Application Publication
(10) Pub. No.: US 2025/0367075 A1
(43) Pub. Date: Dec. 4, 2025

(54) Intravenous Bag with Positive Insignia

(71) Applicant: Kimberly Terase Askew, Henderson, NV (US)

(72) Inventor: Kimberly Terase Askew, Henderson, NV (US)

(21) Appl. No.: 18/676,548

(22) Filed: May 29, 2024

(51) Int. Cl. A61J 1/10

(52) U.S. Cl. CPC A61J 1/10; A61J 2205/50

(57) ABSTRACT

An IV bag is adapted with positive insignia on empty spaces to provide some positive energy, thoughts, and even laughter and happiness to a patient who is receiving IV fluids from the bag. Such insignia can help improve a patient's mental mindset, encourage, spread positivity, and ultimately improve patient outcomes-backed by proven research. Insignia can include graphics, printed text, etc. The insignia on the IV bags may be printed during the manufacturing process along with the typical functional information printed on the IV bag. The printed insignia may be comprised of a variety of colors to take away from the dull printed matter currently on the IV bags. The positive insignia may be printed before, after, or contemporaneously with the printing of the generic informational insignia. Sales of the IV bags can be donated to foundations that, for example, provide financial assistance to underserved communities.

### BACKGROUND

Typically, intravenous (IV) bags have printed text on a single side that presents various functional information about the specific bag, manufacturer, etc. Medical providers may place an informational sticker on the IV bags to provide further patient-specific information. However, there is still a lot of wasted real estate on these IV bags. There is a lot of wasted space on the bags currently that could be used to improve the mental mindset of the patient, and encourage and spread positivity. Various studies have proven that a positive mindset improves prognosis and a better outcome for a patient.

### SUMMARY

An IV bag is adapted with positive insignia on empty spaces to provide some positive energy, thoughts, and even laughter and happiness to a patient who is receiving IV fluids from the bag. Such insignia can help improve a patient's mental mindset, encourage, spread positivity, and ultimately improve patient outcomes-backed by proven research. Insignia can include graphics, printed text, etc.

The insignia on the IV bags may be printed during the manufacturing process along with the typical functional information printed on the IV bag. The printed insignia may be comprised of a variety of colors to take away from the dull printed matter currently on the IV bags. While printed matter may be used, stickers placed on the IV bag sometime after its manufacture are also possible, including written matter with crayons, markers, paint, etc. The positive insignia may be printed before, after, or contemporaneously with the printing of the generic informational insignia. Sales of the IV bags can be donated to foundations that, for example, provide financial assistance to underserved communities, conduct studies in pursuit of a cure for cancer, and prolong the lives of cancer patients. For example, the seller of the IV bags can take proceeds and support their own foundation dedicated to various causes.

In addition to placing positive insignia on IV bags, such positive insignia can likewise be placed on ID bracelets, gowns, and other hospital items to even further spread positive encouragement. Sales of such items can likewise be donated to charities, foundations, and the like.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of the front side of an IV bag; and

FIG. 2 shows an illustrative representation of a rear side of the IV bag having various positive insignia thereon.

Like reference numerals indicate like elements in the drawings. Elements are not drawn to scale unless otherwise indicated.

### DETAILED DESCRIPTION

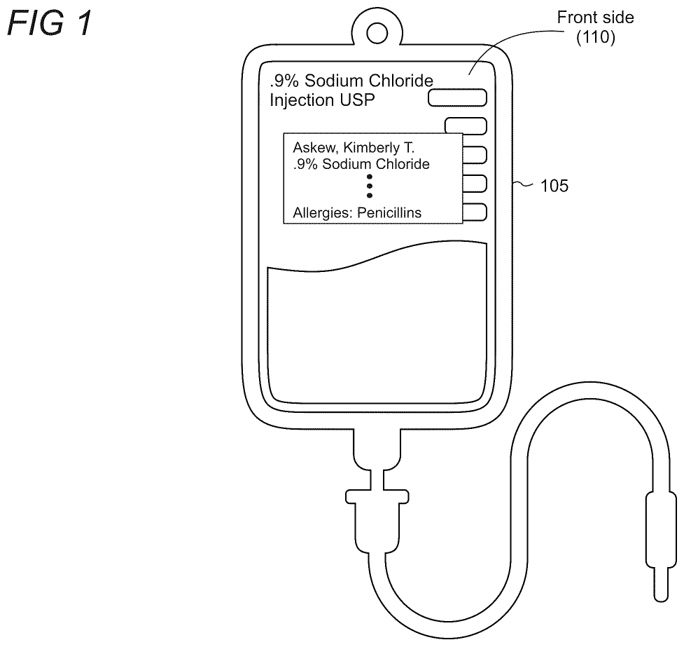

FIG. 1 shows an illustrative representation in which an intravenous (IV) bag 105 carries liquid delivered to a patient, such as at a hospital. The IV bag can hold any number of medicines, vitamins, supplements, etc., to deliver the necessary fluids, medications, or nutrition directly into the user's bloodstream via their veins. Some people, like cancer patients, may routinely receive fluids via IV bags. Over time, such activity can instill wear and tear on a patient's morale. For example, FIG. 1 shows one of the IV bag's sides, its front side 110, having various functional information printed thereon, making a relatively boring and debilitating activity even duller.

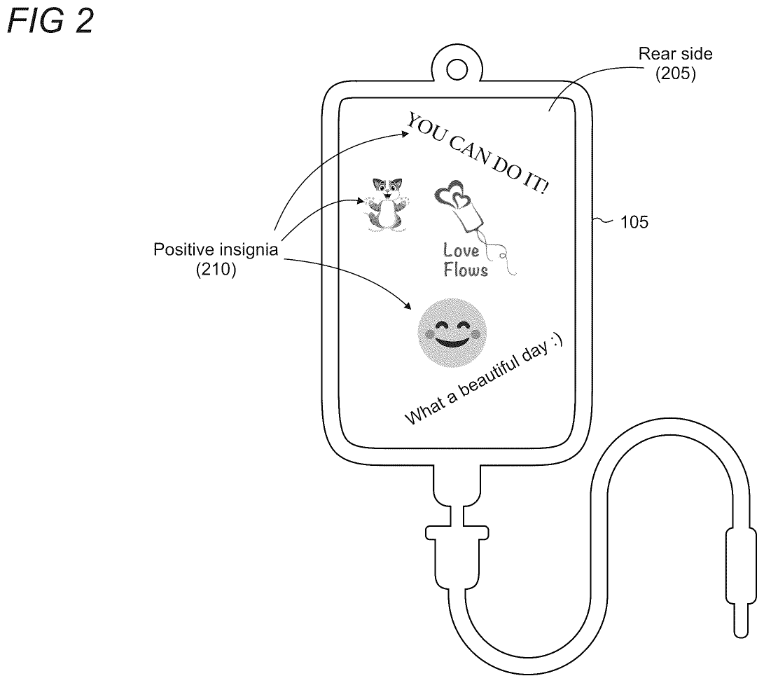

FIG. 2 shows an illustrative representation of the IV bag's rear side 205, which includes various positive insignia 210. Such positive insignia can include a variety of colors, images, graphics, printed text, etc., to convey positivity to patients and any person within observable distance of the IV bag. Printed insignia can be done before, after, or contemporaneously with the printed functional information on the IV bags. While the informational content may be in a single color, such as black, the positive insignia may be multi-colored in typical implementations, such as with bright colors or colors typically associated with positive emotions. Exemplary printed insignia shown in FIG. 2 include smiley faces, positive phrases, animals, etc. While the positive insignia is shown on a single rear side of the IV bag 105, the positive insignia may alternatively or additionally be placed throughout the IV bag, such as on its edges, on the tubing, covering some informational functional material (that is not important for treatment), among other places. The positive insignia may leverage any and all empty and unused real estate to ensure positive messages are conveyed to their fullest extent.

While printed matter is one method of placing positive insignia on the IV bag, other methods are also possible, such as written insignia from paint, crayons, markers, stickers, etc. For example, perhaps children can decorate an IV bag or a series of IV bags that they use themselves or other people can use. Such IV bags can be sold, and proceeds from their sale can be donated to various charities or foundations, such as for underserved communities, conduct studies in pursuit of a cure for cancer, and prolong cancer patients' lives.

In addition to placing positive insignia on IV bags, such positive insignia can likewise be placed on ID bracelets, gowns, and other hospital items to even further spread positive encouragement. Sales of such items can likewise be donated to charities, foundations, and the like. For example, the seller of the IV bags can create their own foundation and support it with IV bag proceeds, so that the seller can invest in their own causes.

Various exemplary embodiments are disclosed herein. In one exemplary embodiment, implemented is an intravenous (IV) bag, comprising: printed functional matter on the side of the IV bag; and printed insignia in a variety of colors, wherein the printed insignia includes graphics and text.

In another example, the printed insignia is printed on the IV bag contemporaneously as the functional matter during a manufacturing method. As another example, the printed insignia also printed on a same side as the printed functional matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An intravenous (IV) bag, comprising:
printed functional matter on the side of the IV bag; and
printed insignia in a variety of colors, wherein the printed insignia includes graphics and text.

2. The IV bag of claim 1, wherein the printed insignia is printed on the IV bag contemporaneously as the functional matter during a manufacturing method.

3. The IV bag of claim 1, wherein the printed insignia also printed on a same side as the printed functional matter.
